(19) United States
(12) Patent Application Publication
(10) Pub. No.: US 2025/0028181 A1
(43) Pub. Date: Jan. 23, 2025

(54) PROGRAMABLE OPTICAL COUPLER AND METHODS FOR BEAM ROUTING AND BEAM SHAPING

(71) Applicant: LIGHTSOLVER LTD., Tel Aviv (IL)

(72) Inventors: Chene TRADONSKY, Rehovot (IL); Ruti RAN BEN SHLOMI, Caesarea (IL)

(73) Assignee: LIGHTSOLVER LTD., Tel Aviv (IL)

(21) Appl. No.: 18/908,017

(22) Filed: Oct. 7, 2024

Related U.S. Application Data
(63) Continuation of application No. PCT/IL2023/050376, filed on Apr. 4, 2023.
(60) Provisional application No. 63/328,518, filed on Apr. 7, 2022.

(51) Int. Cl. G02B 27/12

(52) U.S. Cl. CPC G02B 27/123

(57) ABSTRACT

A programmable optical coupler may include: a beam splitter configured to receive array of laser beams distributed along a first axis, and split each of laser beams into split laser beams distributed along second axis, in accordance with a first user-defined intensity distribution, wherein the first axis is substantially perpendicular to the second axis; a phase correction unit configured to receive the split laser beams of each of said array of laser beams, and individually apply a user-defined phase correction thereto, to yield phase-corrected split laser beams of each of the array of laser beams; and a beam combiner configured to receive the phase-corrected split laser beams, and combine the phase-corrected split laser beams of the array of laser beams into a single combined array of laser beams distributed along the second axis, in accordance with a second user-defined intensity distribution.

### CROSS-REFERENCE TO RELATED APPLICATIONS

This Application is a Continuation of PCT Application No. PCT/IL2023/050376, International filing date Apr. 4, 2023, which claims the benefit of U.S. Provisional Patent Application No. 63/328,518, filed on Apr. 7, 2022, which is incorporated herein in its entirety.

### FIELD OF THE INVENTION

The present invention relates generally to the field of electro optics, and more particularly to a programmable optical coupler using beam routing, beam shaping, and optical vector-matrix multiplication.

### BACKGROUND OF THE INVENTION

Many problems in the physical world may be represented or modelled with linear algebra. For example, physical systems and problems may be represented by systems of linear equations or linear maps. Systems of linear equations and linear maps may be expressed using matrices. Linear algebra calculations may be executed using conventional general-purpose computers, and thus, predictions and calculations concerning physical systems that are able to be represented through linear algebra may be obtained. Linear algebra calculations may, for example, be achieved through execution of matrix multiplication algorithms on general-purpose computers. However, matrix multiplication algorithms may have a high computational complexity or time complexity (e.g., polynomial complexity). Thus, for large matrices, calculations may take a relatively long time to execute.

Thus, there may be a desire in the art for systems and methods that rapidly make predictions or calculations concerning physical systems that are able to be represented through linear algebra. There may be a desire in the art for an optical coupler which is programmable and configurable for a variety of operations.

### SUMMARY OF THE INVENTION

According to some embodiments of the present invention a programmable optical coupler is provided herein. The programmable optical coupler may include: a beam splitter configured to receive an array of a plurality of laser beams distributed along a first axis, and split each of the plurality of laser beams into a plurality of split laser beams distributed along a second axis, in accordance with a first user-defined intensity distribution, and wherein the first axis is substantially perpendicular to the second axis; a phase correction unit configured to receive the plurality of split laser beams of each of said array of a plurality of laser beams, and individually apply a user-defined phase correction thereto, to yield phase-corrected split laser beams of each of said array of a plurality of laser beams; and a beam combiner configured to receive said phase-corrected split laser beams, and combine the phase-corrected split laser beams of said array of a plurality of laser beams into a single combined array of a plurality of laser beams distributed along the second axis, in accordance with a second user-defined intensity distribution.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic drawing of a programmable optical coupler according to some embodiments of the invention;

FIG. 2 is a schematic drawing of a programmable optical coupler according to some embodiments of the invention;

FIG. 3A is a schematic drawing of a y-axis beam reshaping unit according to some embodiments of the invention;

FIG. 3B is a schematic drawing of an x-axis beam reshaping unit according to some embodiments of the invention;

FIG. 4 is a schematic drawing of a programmable optical coupler according to some embodiments of the invention; and

FIG. 5 is a flowchart diagram illustrating a method according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. In addition, optical diagrams are schematic and do not show the exact paths of the light rays as they change media. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

A mathematical problem that embodiments of the present invention may be suited to solve quickly and efficiently may be defined as follows. This can be presented as a vector-matrix multiplication problem:

Vₒᵤₜ=MVᵢₙ

wherein there may be an input vector Vᵢₙ, which may be represented by a column vector of size n, there may be an output vector Vₒᵤₜ, which may be represented by a row vector of size p, and there may be a matrix M of size p×n, which may, for example, be expressed as:

$$[ \begin{matrix}{m}_{11} & {m}_{12} & … & {m}_{1 n} \\ {m}_{21} & {m}_{22} & … & {m}_{2 n} \\ ⋮ & ⋮ & ⋱ & ⋮ \\ {m}_{p 1} & {m}_{p 2} & … & {m}_{pn}\end{matrix} ]$$

wherein Σₖ|mₖₗ|²≤1, and each matrix element may be represented as mₖₗ=|mₖₗ|exp(iϕₖₗ), with a magnitude |mₖₗ| and a phase ϕₖₗ. In some embodiments, p=n, and thus, in said embodiments, matrix M may be of size n×n. The term Σₖ|mₖₗ|²≤1may be related to conserving energy in a physical system that the vector-matrix multiplication problem may represent.

Matrix M may be represented as an element-wise product (or Hadamard product) of three matrices A, B and Θ, each of which have the same dimensions as matrix M

$$M = A ∘ Θ ∘ B$$

$${m}_{kl} = {a}_{kl} {Θ}_{kl} {b}_{kl}$$

wherein elements of matrices A, B and Θ are given by:

$${a}_{kl} = \vert {a}_{kl} \vert exp ( i {ϕ}_{{a}_{kl}} )$$

$${b}_{kl} = \vert {b}_{kl} \vert exp ( i {ϕ}_{{b}_{kl}} )$$

$${Θ}_{kl} = exp ( i {θ}_{kl} )$$

respectively. Matrix A may be called the first beam shaping matrix, matrix B may be called the second beam reshaping matrix, and matrix Θ may be called the phase corrections matrix.

Matrices A and B may also be energy conserving matrices that include desirable and undesirable losses, such that Σₖaₖₗ²≤1, Σₖbₖₗ²≤1. Combining formulae given above may give expressions for magnitude and phase of matrix M

$${m}_{kl} = \vert {m}_{kl} \vert exp ( i {ϕ}_{kl} ) = \vert {a}_{kl} ‖ {b}_{kl} \vert exp ( i ( {θ}_{kl} + {ϕ}_{{a}_{kl}} + {ϕ}_{{b}_{kl}} ) )$$

$$∴ \vert {m}_{kl} \vert = \vert {a}_{kl} ‖ {b}_{kl} \vert$$

$$∴ {θ}_{kl} = {ϕ}_{kl} - {ϕ}_{{a}_{kl}} - {ϕ}_{{b}_{kl}}$$

Vector-matrix multiplication may represent many systems or problems, and quickly and efficiently calculating a vector-matrix multiplication may be useful for a variety of uses.

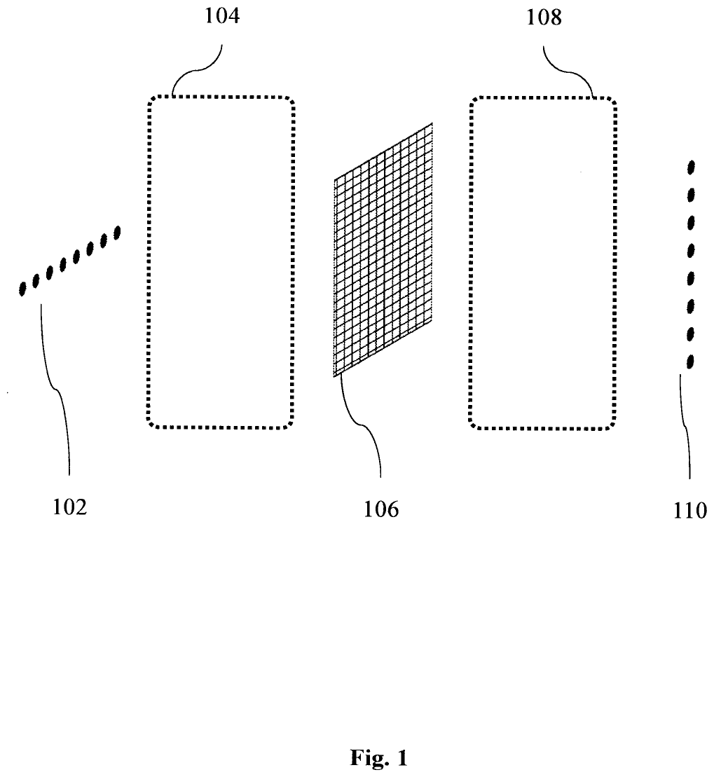

FIG. 1 shows a basic diagram of a programmable optical coupler according to some embodiments of the present invention. The programmable optical coupler of FIG. 1 may be configured to solve vector-matrix multiplication problems quickly and efficiently.

The programmable optical coupler may be configured to receive an array of input light beams 102. The light beams may be produced by one or more light beam emitters (not depicted), such as laser emitters/sources. Each light beam may have a distinct (intensity or amplitude) magnitude, and/or a distinct phase. The magnitude and phase values of each light beam may be in accordance with user-defined distributions for magnitude and phase (for example, the magnitude and phase of each beam may represent the magnitude and phase of each element of an input vector, such as Vᵢₙ). The magnitude and phase values of each light beam may be controlled by the one or more light beam emitters, wherein the light beam emitters may be configured to be controllable, such that light beams are emitted with the user-defined distributions for magnitude and phase. The direction of travel of the light beams during operation of the programmable optical coupler may be through the programmable optical coupler (for example, from the array of input light beams 102 through each component to an array of output light beams 110). The array of input light beams may be arranged along an axis known as an x-axis. It will be appreciated that the exact orientation of the x-axis is arbitrary. For example, the x-axis may be, but need not be, horizontal. The x-axis may be substantially perpendicular to the direction of travel of the input light beams.

The programmable optical coupler may comprise a y-axis beam reshaping unit 104. The y-axis beam reshaping unit may also be known as a y-axis beam splitter. The y-axis beam reshaping unit may be configured to receive the array of input beams. The y-axis beam reshaping unit may be configured to split each light beam of the array of input light beams into a plurality of split beams. Each split beam of the plurality of split beams may be arranged/disposed/stretched along a y-axis, wherein the y-axis may be substantially perpendicular to the x-axis. The y-axis may be substantially perpendicular to the direction of travel of the input light beams. The y-axis reshaping unit may be configured to output a first two-dimensional array of light beams. The first two-dimensional array of light beams may also be known as a first intermediate array of light beams. In some embodiments, the y-axis beam reshaping unit may be configured to apply a phase/intensity change/correction as represented by matrix A. The y-axis beam reshaping unit may comprise at least one optical element (such as a lens) for dispersing the array of input beams in the y-axis and may comprise at least one optical modulator (such as a spatial light modulator) for causing an interference pattern of the light, in order that a two-dimensional array of light beams may be outputted.

The programmable optical coupler may comprise a phase correction unit 106. The phase correction unit may be configured to receive the first two-dimensional array of light beams. The phase correction unit may be configured to apply a (possibly distinct) phase change/correction to each light beam of the first two-dimensional array of light beams. Additionally, or alternatively, the phase correction unit may be configured to apply a (possibly distinct) intensity change/correction to each light beam of the first two-dimensional array of light beams. The intensity change/correction may maintain the intensity of a light beam or reduce the intensity of a light beam. In some embodiments, the phase correction unit may be or may include a spatial light modulator (SLM) and/or a digital micromirror device (DMD). The phase correction unit may comprise a number of pixels arranged in an xy-plane (plane defined by x-axis and y-axis), wherein each pixel may be configured to apply a phase change and/or a transmission change to light that passes through it. The phase correction unit may be configured to output a second two-dimensional array of light beams. The second two-dimensional array of light beams may also be known as a second intermediate array of light beams. In some embodiments, the phase correction unit may be configured to apply a phase correction as represented by matrix Θ.

The programmable optical coupler may comprise an x-axis beam reshaping unit 108. The x-axis beam reshaping unit may also be known as an x-axis beam combiner. The x-axis beam reshaping unit may be configured to receive the second two-dimensional array of light beams. The x-axis beam reshaping unit may be configured to combine the light beams of each one-dimensional x-axis array of the second two-dimensional array of light beams into a single light beam for each one-dimensional x-axis array, so as to produce an array of output light beams, which may be arranged in the y-axis. Each combined light beam may interfere with at least one other light beam (e.g., constructively interfere or destructively interfere), wherein the interference may be based on the phase and intensity of each light beam. In some embodiments, the x-axis beam reshaping unit may be configured to apply a phase/intensity change/correction as represented by matrix B. The x-axis beam reshaping unit may comprise at least one optical element (such as a lens) for focussing arrays in the x-axis and may comprise at least one optical modulator (such as a spatial light modulator) for combining an interference pattern of the light, in order that an array of output light beams may be outputted in the y-axis.

The programmable optical coupler may be configured to output an array of output light beams 110, which may be arranged along the y-axis (substantially perpendicular to the array of input light beams). The array of output light beams may be detected, by one or more light detectors (not depicted), such as a camera or a charge-coupled device (CCD). Each light beam may have a distinct (intensity) magnitude, and/or a distinct phase, of which, at least one may be detected by the one or more light detectors.

The programmable optical coupler may further comprise a control unit (not depicted). The control unit may include/comprise/utilise a computing device. The computing device may include a controller or computer processor that may be, for example, a central processing unit processor (CPU), a chip or any suitable computing device; an operating system; a memory; a storage; input devices, which may for example be used to ascertain user-defined distributions; and output devices, such as a computer display or monitor displaying, for example, a computer desktop system. The control unit may be configured to control the optical properties of the components of the programmable optical coupler, for example, in accordance with user-defined distributions, which may in some embodiments also be ascertained by the control unit. For example, the control unit may change the optical properties of the light beam emitters, the y-axis beam reshaping unit, the phase correction unit, the x-axis beam reshaping unit, or any other components thereof (e.g. spatial light modulators and digital micromirror devices).

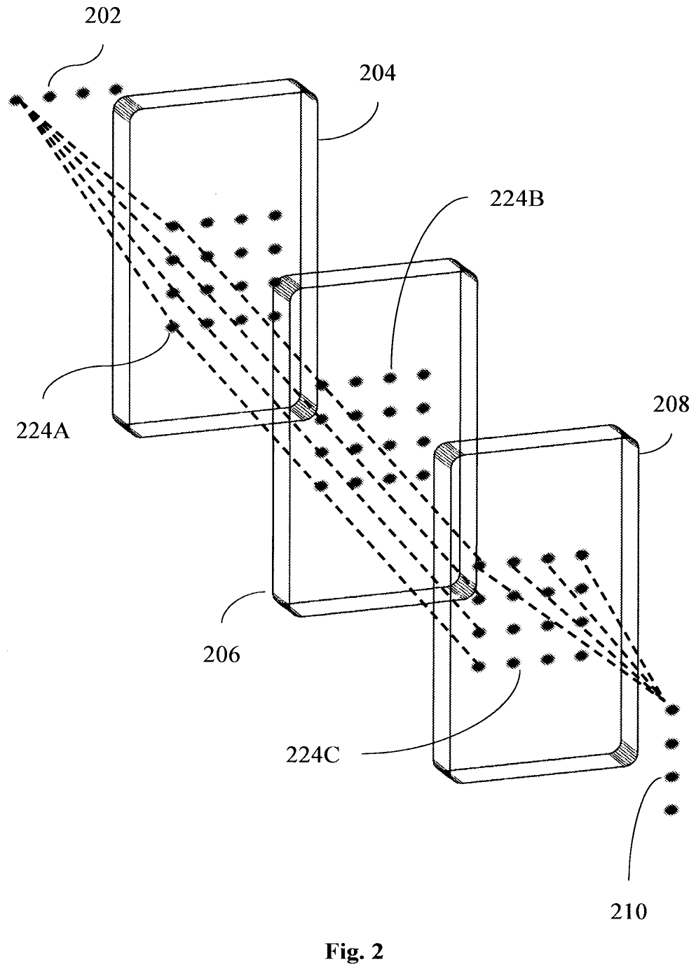

FIG. 2 shows a basic diagram of a programmable optical coupler according to some embodiments of the present invention. The programmable optical coupler of FIG. 2 may be configured to solve vector-matrix multiplication problems quickly and efficiently. FIG. 2 additionally displays a simplified path of light beams travelling through the programmable optical coupler.

The programmable optical coupler may be configured to receive an array of input light beams 202. The light beams may be produced by one or more light beam emitters (not depicted). Each light beam may have a distinct (intensity) magnitude, and/or a distinct phase. The array of input light beams may be similar to, or the same as, input light beams 102 of FIG. 1, and the light beam emitters may be similar to, or the same as, the light beam emitters as described in relation to FIG. 1.

The programmable optical coupler may comprise a y-axis beam reshaping unit 204. The y-axis beam reshaping unit may be similar to, or the same as, y-axis reshaping unit 104 of FIG. 1. The y-axis beam reshaping unit may be configured to receive the array of input light beams and output a first two-dimensional array of light beams 224A. The first two-dimensional array of light beams may be arranged in an xy-plane. The first two-dimensional array of light beams may have the same number of beams in the x-axis direction as the array of input light beams 202.

The programmable optical coupler may comprise a phase correction unit 206. The phase correction unit may be similar to, or the same as, phase correction unit 106 of FIG. 1. The phase correction unit 206 may be configured to receive the first two-dimensional array of light beams 224A and, after a phase and/or intensity change/correction, output a second two-dimensional array of light beams 224B.

The programmable optical coupler may comprise an x-axis beam reshaping unit 208. The x-axis beam reshaping unit may be similar to, or the same as, x-axis beam reshaping unit 108 of FIG. 1. The x-axis beam reshaping unit 208 may be configured to receive the second two-dimensional array of light beams (which may have propagated some distance along the programmable optical coupler) 224C and output an array of output light beams 210.

The programmable optical coupler may be configured to output the array of output light beams 210, which may be arranged along the y-axis (substantially perpendicular to the array of input light beams). The array of output light beams may be detected, by one or more light detectors (not depicted), such as a camera or a charge-coupled device (CCD). Each light beam may have a distinct (intensity) magnitude, and/or a distinct phase, of which, at least one may be detected by the one or more light detectors. The array of output light beams may be similar to, or the same as, the output light beam 110 of FIG. 1, and the light detectors may be similar to, or the same as, the light detectors as described in relation to FIG. 1.

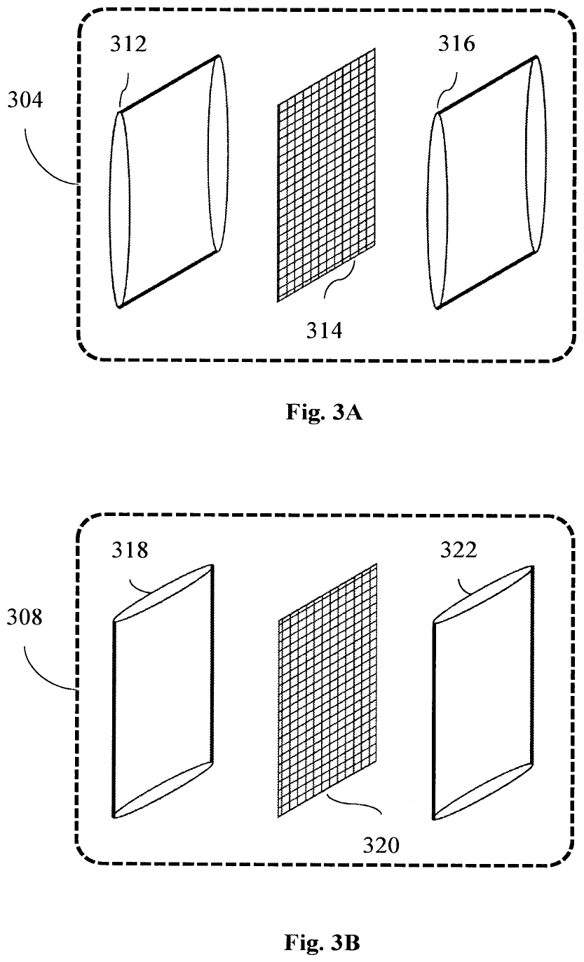

FIG. 3A shows an example embodiment of a y-axis beam reshaping unit 304. The y-axis beam reshaping unit 304 may be used in programmable optical couplers, such as the programmable optical couplers of FIGS. 1 and 2. The y-axis beam reshaping unit may be configured to receive an array of input light beams (possibly arranged along the x-axis) (e.g. 102 and 202) and may be configured to output a first two-dimensional array of light (e.g. 224A).

The y-axis beam reshaping unit 304 may comprise a first y-axis optical element 312. The first y-axis optical element may be configured to receive the array of input light beams and may disperse each light beam of the array of input light beams in the y-axis direction. The first y-axis optical element may be configured to neither substantially focus nor substantially disperse the shape of the array of input light beams in the x-axis direction. The first y-axis optical element may be/comprise a cylindrical (or substantially cylindrical) lens, wherein a cylinder axis coincides with the x-axis. The first y-axis optical clement may be/comprise a convex lens or a concave lens.

The y-axis beam reshaping unit 304 may comprise a y-axis light modulator 314. The y-axis light modulator may be configured to apply a (possibly distinct) phase change/correction to input light. Additionally or alternatively, the y-axis light modulator may be configured to apply a (possibly distinct) intensity change/correction to input light. The intensity change/correction may maintain the intensity of the input light or reduce the intensity of the input light. In some embodiments, the y-axis light modulator may be or may include a spatial light modulator (SLM) and/or a digital micromirror device (DMD). The y-axis light modulator may comprise a number of pixels arranged in an xy-plane (plane defined by x-axis and y-axis), wherein each pixel may be configured to apply a phase change and/or a transmission change to light that passes through it. The phase and intensity changes of the y-axis light modulator may correspond to matrix A. The y-axis light modulator may be configured to apply a phase and/or intensity mask/pattern to the incoming light, in order that the light splits into a required number of light beams. The mask/pattern may be defined by a Fourier transform of a function which describes a pattern required at the phase correction unit.

The y-axis beam reshaping unit 304 may comprise a second y-axis optical element 316. The second y-axis optical element may be configured to output the first two-dimensional array of light beams. The second y-axis optical clement may focus each input light beam in the y-axis. The second y-axis optical element may be configured to neither substantially focus nor substantially disperse the shape of input light in the x-axis. The second y-axis optical clement may comprise a cylindrical (or substantially cylindrical) lens, wherein a cylinder axis coincides with the x-axis. The second y-axis optical element may be/comprise a convex lens. The second y-axis optical element may be configured to converge the light beams into a substantially parallel configuration.

FIG. 3B shows an example embodiment of an x-axis beam reshaping unit 308. The x-axis beam reshaping unit 308 may be used in programmable optical couplers, such as the programmable optical couplers of FIGS. 1 and 2. The x-axis beam reshaping unit may be configured to receive a second two-dimensional array of light beams (e.g. 224C) and may be configured to output an array of output light beams (possibly arranged along the y-axis) (e.g. 224A).

The x-axis beam reshaping unit 308 may comprise a first x-axis optical element 318. The x-axis optical element may be configured to receive the second two-dimensional array of light beams and may focus each light beam of the second two-dimensional array of light beams in the x-axis. The first x-axis optical element may be configured to neither substantially focus nor substantially disperse the shape of input light in the y-axis. The first x-axis optical element may comprise a cylindrical (or substantially cylindrical) lens, wherein a cylinder axis coincides with the y-axis. The first x-axis optical element may be/comprise a convex lens.

The x-axis beam reshaping unit 308 may comprise an x-axis light modulator 320. The x-axis light modulator may be configured to apply a (possibly distinct) phase change/correction to input light. Additionally, or alternatively, the x-axis light modulator may be configured to apply a (possibly distinct) intensity change/correction to input light. The intensity change/correction may maintain the intensity of the input light or reduce the intensity of the input light. In some embodiments, the x-axis light modulator may be or may include a spatial light modulator (SLM) and/or a digital micromirror device (DMD). The x-axis light modulator may comprise a number of pixels arranged in an xy-plane (plane defined by x-axis and y-axis), wherein each pixel may be configured to apply a phase change and/or a transmission change to light that passes through it. The phase and intensity changes of the x-axis light modulator may correspond to matrix B. The x-axis light modulator may be configured to apply a phase and/or intensity mask/pattern to the incoming light, in order that the light combines into one light beam (for each array along an x-axis). The mask/pattern may be defined by a Fourier transform of a function which describes a pattern required at the output.

The x-axis beam reshaping unit 308 may comprise a second x-axis optical element 322. The second x-axis optical clement may be configured to output the array of output light beams. The second x-axis optical element may focus each input light beam in the x-axis. The second x-axis optical element may be configured to neither substantially focus nor substantially disperse the shape of input light in the y-axis. The second x-axis optical element may comprise a cylindrical (or substantially cylindrical) lens, wherein a cylinder axis coincides with the y-axis. The second y-axis optical element may be/comprise a convex lens or a concave lens.

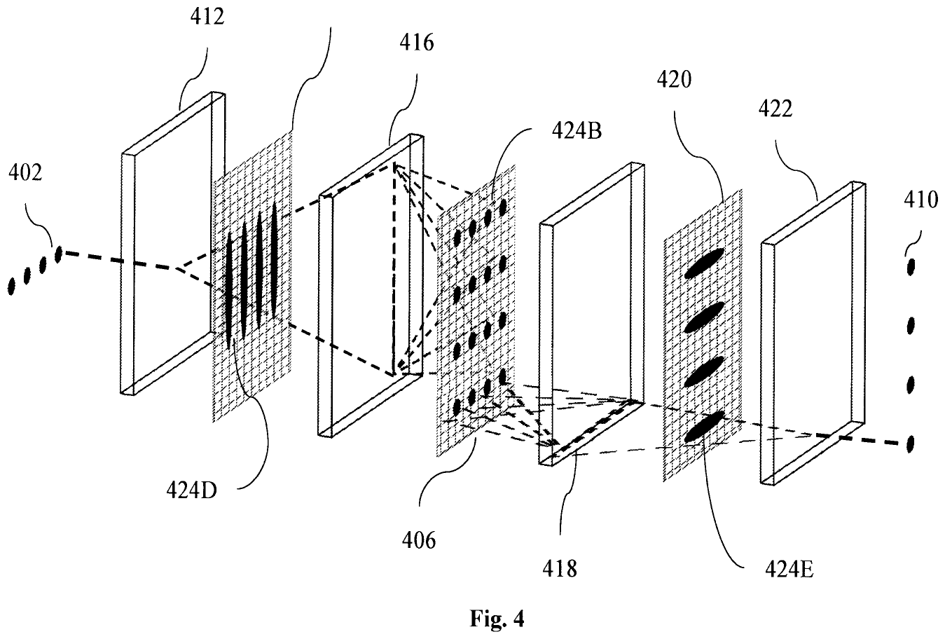

FIG. 4 shows a basic diagram of a programmable optical coupler according to some embodiments of the present invention. The programmable optical coupler of FIG. 4 may be configured to solve vector-matrix multiplication problems quickly and efficiently. FIG. 4 additionally displays a simplified path of light beams travelling through the programmable optical coupler.

The programmable optical coupler may be configured to receive an array of input light beams 402. The light beams may be produced by one or more light beam emitters (not depicted). Each light beam may have a distinct (intensity) magnitude, and/or a distinct phase. The array of input light beams may be similar to, or the same as, input light beams 102 of FIGS. 1 and 202 of FIG. 2, and the light beam emitters may be similar to, or the same as, the light beam emitters as described in relation to FIG. 1 and FIG. 2. The array of input light beams may each have a magnitude and phase of the light. The magnitude and phase of the light of each light beam may be controlled (e.g. by the light beam emitters and the control unit), such that they correspond to the respective magnitude and phase of elements of an input vector (e.g. Vᵢₙ), which may be user defined (or defined by a separate computational device). For example, a matrix may have a first element with a magnitude of 5 (in arbitrary units) and a phase of π/2 and a second element of magnitude 10 (in arbitrary units) and a phase of 3π/2. The array of input light beams may have a corresponding first beam, and a corresponding second beam, wherein the second beam may have a magnitude twice that of the first beam (possibly corresponding to a light intensity four times higher) and the second beam may have a phase difference of It compared to the first beam.

The programmable optical coupler may comprise a first y-axis optical element 412. The first y-axis optical element may be configured to receive the array of input light beams and may disperse each light beam of the array of input light beams in the y-axis direction. The first y-axis optical element may be configured to neither substantially focus nor substantially disperse the shape of the array of input light beams in the x-axis direction. The first y-axis optical element may comprise a cylindrical (or substantially cylindrical) lens, wherein a cylinder axis coincides with the x-axis. The first y-axis optical element may be similar to, or the same as, the first y-axis optical element 312 of FIG. 3A.

The programmable optical coupler may comprise a y-axis light modulator 414. The y-axis light modulator may be or may include a spatial light modulator (SLM) and/or a digital micromirror device (DMD). The y-axis light modulator may be similar to, or the same as, the y-axis light modulator 314 of FIG. 3A. A first array of stretched light beams 424D may be incident on the y-axis light modulator.

The programmable optical coupler may comprise a second y-axis optical element 416. The second y-axis optical element may be configured to output the first two-dimensional array of light beams. The second y-axis optical element may focus each input light beam in the y-axis. The second y-axis optical element may be configured to neither substantially focus nor substantially disperse the shape of input light in the x-axis direction. The second y-axis optical element may comprise a cylindrical (or substantially cylindrical) lens, wherein a cylinder axis coincides with the x-axis. The second y-axis optical element may be similar to, or the same as, the second y-axis optical clement 316 of FIG. 3A.

The programmable optical coupler may comprise a phase correction unit 406. The phase correction unit may be similar to, or the same as, phase correction unit 106 of FIG. 1 or 206 of FIG. 2. The phase correction unit 406 may be configured to receive a first two-dimensional array of light beams (e.g. 424A) and, after a phase and/or intensity change/correction, output a second two-dimensional array of light beams 424B. The phase correction unit may perform an intensity and/or phase change on the incoming light beams that may be in accordance with matrix Θ (e.g. each beam of the first two-dimensional array of beams may be incident on a pixel of the phase correction unit that performs the operation of the matrix Θ at the corresponding position).

The programmable optical coupler may comprise a first x-axis optical element 418. The x-axis optical element may be configured to receive a second two-dimensional array of light beams 424B and may focus each light beam of the second two-dimensional array of light beams in the x-axis, while neither substantially focussing nor substantially dispersing the shape of input light in the y-axis. The first x-axis optical element may comprise a cylindrical (or substantially cylindrical) lens, wherein a cylinder axis coincides with the y-axis. The first x-axis optical element may be similar to, or be the same as, the first x-axis optical element 318 of FIG. 3B.

The programmable optical coupler may comprise an x-axis light modulator 420. The x-axis light modulator may be or may include a spatial light modulator (SLM) and/or a digital micromirror device (DMD). The x-axis light modulator may be similar to, or be the same as, the x-axis light modulator 320 of FIG. 3B. A second array of stretched light beams 424E may be incident on the x-axis light modulator.

The programmable optical coupler may comprise a second x-axis optical element 422. The second x-axis optical element may be configured to output the array of output light beams. The second x-axis optical clement may focus each input light beam in the x-axis, while neither substantially focussing nor substantially dispersing the shape of input light in the y-axis. The second x-axis optical element may comprise a cylindrical (or substantially cylindrical) lens, wherein a cylinder axis coincides with the y-axis. The second x-axis optical element may be similar to, or be the same as, the second x-axis optical clement 322 of FIG. 3B.

The programmable optical coupler may be configured to output the array of output light beams 410, which may be arranged along the y-axis (substantially perpendicular to the array of input light beams). The array of output light beams may be detected, by one or more light detectors (not depicted), such as a camera or a charge-coupled device (CCD). Each light beam may have a distinct (intensity) magnitude, and/or a distinct phase, of which, at least one may be detected by the one or more light detectors. The array of output light beams may be similar to, or the same as, output light beams 102 of FIGS. 1 and 202 of FIG. 2. The magnitude and phase of the light of each light beam may correspond to the respective magnitude and phase of elements of an output vector (e.g. Vₒᵤₜ), which may be the result of a multiplication between user defined (or defined by a separate computational device) matrix M and vector Vᵢₙ. For example, an output vector may have a first element with a magnitude of 6 and a phase of 0 and a second element of magnitude 9 and a phase of π/2. The array of output light beams may have a corresponding first beam, and a corresponding second beam, wherein the second beam may have a magnitude 1.5 times that of the first beam (possibly corresponding to a light intensity 2.25 times higher) and the second beam may have a phase difference of π/2 compared to the first beam.

In some embodiments, the one or more light detectors, such as a camera or CCD, may be able to detect an intensity of the light incident on the light detector (which may be proportional to the square of the magnitude of the light), but may be unable to detect a phase of the light incident on the light detector. For example, many cameras are unable to detect a light phase. In some embodiments, a phase retrieval algorithm may be used to calculate the phase of the incident light.

Some embodiments of the present invention may comprise a method for performing vector-matrix multiplication (such as the vector-matrix multiplication described above) using a programmable optical coupler.

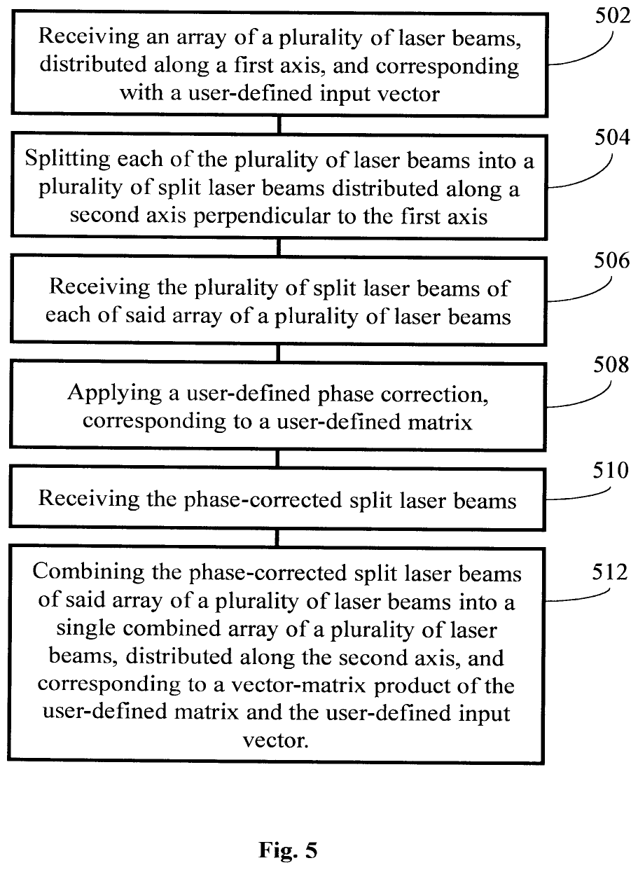

FIG. 5 shows a flowchart of a method according to some embodiments of the present invention. The method may be performed by a programmable optical coupler according to embodiments of the invention.

In step 502, a beam splitter may receive an array of a plurality of laser beams distributed along a first axis, wherein the array of a plurality of laser beams distributed along a first axis may correspond with a user-defined input vector.

In step 504, a beam splitter may split each of the plurality of laser beams into a plurality of split laser beams distributed along a second axis, wherein the first axis may be substantially perpendicular to the second axis.

The beam splitter of step 504 may also be the beam splitter of step 502.

In step 506, a phase correction unit may receive the plurality of split laser beams of each of said array of a plurality of laser beams.

In step 508, a phase correction unit may apply a user-defined phase correction, wherein the user-defined phase correction may correspond to a user-defined matrix.

The phase correction unit of step 508 may also be the phase correction unit of step 506.

In step 510, a beam combiner may receive the phase-corrected split laser beams.

In step 512, a beam combiner may combine the phase-corrected split laser beams of said array of a plurality of laser beams into a single combined array of a plurality of laser beams distributed along the second axis, wherein the single combined array of a plurality of laser beams distributed along the second axis may correspond to a vector-matrix product of the user-defined matrix and the user-defined input vector.

The beam combiner of step 512 may also be the beam combiner of step 510.

In order to implement the programmable optical coupler and the method according to embodiments of the present invention, a computer processor may receive instructions and data from a read-only memory or a random-access memory or both and communicate signals with the programmable optical coupler as known in the art. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment”, “an embodiment”, or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional elements.

It is to be understood that where the claims or specification refer to “a” or “an” element, such reference is not construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications 10 are also within the scope of the invention. Accordingly, the scope of the invention should not be limited by what has thus far been described, but by the appended claims and their legal equivalents.

1. A programmable optical coupler comprising:
a beam splitter configured to receive an array of a plurality of laser beams distributed along a first axis, and split each of the plurality of laser beams into a plurality of split laser beams distributed along a second axis, in accordance with a first user-defined intensity distribution, and wherein the first axis is substantially perpendicular to the second axis;
a phase correction unit configured to receive the plurality of split laser beams of each of said array of a plurality of laser beams, and individually apply a user-defined phase correction thereto, to yield phase-corrected split laser beams of each of said array of a plurality of laser beams; and
a beam combiner configured to receive said phase-corrected split laser beams and combine the phase-corrected split laser beams of said array of a plurality of laser beams into a single combined array of a plurality of laser beams distributed along the second axis, in accordance with a second user-defined intensity distribution.

2. The programmable optical coupler according to claim 1, further comprising a control unit, configured to control the optical properties of at least one of: the beam splitter, the phase correction unit, and the beam combiner.

3. The programmable optical coupler according to claim 1, further comprising a plurality of controllable laser sources in a spatially distinguished array, configured to produce the array of a plurality of laser beams distributed along the first axis, each of the plurality of laser beams having a user-defined phase and amplitude.

4. The programmable optical coupler according to claim 1, wherein the beam splitter comprises:
a spatial light modulator; and
at least one of:
a lens, and
a diffractive optical element.

5. The programmable optical coupler according to claim 1, wherein the beam combiner comprises:
a spatial light modulator; and
at least one of:
a lens, and
a diffractive optical element.

6. The programmable optical coupler according to claim 1, wherein the phase correction unit comprises a controllable spatial light modulator.

7. The programmable optical coupler according to claim 1, further comprising at least one light detector, configured to detect the single combined array of a plurality of laser beams distributed along the second axis.

8. The programmable optical coupler according to claim 1, wherein the array of a plurality of laser beams distributed along a first axis corresponds to a user-defined input vector, the user-defined phase correction corresponds to a user-defined matrix, and
wherein the programmable optical coupler is thereby configured to calculate a vector-matrix product of the user-defined input vector and the user-defined matrix, and the single combined array of a plurality of laser beams distributed along the second axis corresponds to said vector-matrix product.

9. A method for performing vector-matrix multiplication using a programmable optical coupler, the method comprising:
receiving, at a beam splitter, an array of a plurality of laser beams distributed along a first axis, wherein the array of a plurality of laser beams distributed along a first axis corresponds with a user-defined input vector;
splitting, at the beam splitter, each of the plurality of laser beams into a plurality of split laser beams distributed along a second axis, wherein the first axis is substantially perpendicular to the second axis;
receiving, at a phase correction unit, the plurality of split laser beams of each of said array of a plurality of laser beams;
applying, at the phase correction unit, a user-defined phase correction, wherein the user-defined phase correction corresponds to a user-defined matrix;
receiving, at a beam combiner, the phase-corrected split laser beams;
combining, at the beam combiner, the phase-corrected split laser beams of said array of a plurality of laser beams into a single combined array of a plurality of laser beams distributed along the second axis, wherein the single combined array of a plurality of laser beams distributed along the second axis corresponds to a vector-matrix product of the user-defined matrix and the user-defined input vector.

10. The method according to claim 9, further comprising:
controlling, at a control unit, the optical properties of at least one of: the beam splitter, the phase correction unit, and the beam combiner.

11. The method according to claim 9, wherein splitting each of the plurality of laser beams into a plurality of split laser beams distributed along a second axis comprises:
dispersing, at a first lens, each beam of the plurality of laser beams along the second axis;
modulating, at a first spatial light modulator, the dispersed laser beams to produce a plurality of diverging split laser beams;
focussing, at a second lens, each beam of the plurality of diverging split laser beams to produce a plurality of split laser beams.

12. The method according to claim 9, wherein combining the phase-corrected split laser beams of said array of a plurality of laser beams into a single combined array of a plurality of laser beams distributed along the second axis comprises:
focussing, at a third lens, each beam of the plurality of phase-corrected split laser beams, to produce a plurality of converging split laser beams;
modulating, at a second spatial light modulator, the converging split laser beams to produce a dispersed single combined array of a plurality of laser beams distributed along the second axis;
collimating, at a fourth lens, each dispersed single combined array of a plurality of laser beams to produce single combined array of a plurality of laser beams distributed along the second axis.

13. The method according to claim 9, further comprising:
producing, at at least one light emitter, an array of a plurality of laser beams distributed along a first axis and corresponding to a user-defined input vector.

14. The method according to claim 13, wherein each laser beam of the array of a plurality of laser beams corresponds to an element of the user-defined input vector, and wherein at least one of an intensity, amplitude, and phase of each laser beam corresponds to a value associated with the corresponding input vector element.

15. The method according to claim 9, further comprising:
detecting, at at least one light detector, at least one of an intensity, amplitude, and phase of each laser beam of the single combined array of a plurality of laser beams.
